(19) United States
(12) Patent Application Publication
(10) Pub. No.: US 2009/0280389 A1
(43) Pub. Date: Nov. 12, 2009

(54) Fuel Cell Separator and Manufacturing Method Thereof

(75) Inventors: Satoshi Tanaka, Tokyo (JP); Kenji Sugawara, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/432,642

(22) Filed: Apr. 29, 2009

(30) Foreign Application Priority Data
May 9, 2008 (JP) 2008-123078
Sep. 17, 2008 (JP) 2008-237502
Sep. 18, 2008 (JP) 2008-239008

(51) Int. Cl. H01M 2/02; C04B 35/00

(52) U.S. Cl. 429/34; 264/104

(57) ABSTRACT

This invention provides a low cost fuel cell separator which reduces a contact resistance between a gas diffusion layer and the separator, has the capability of saving thickness as well as erosion resistance and mechanical strength. It is a feature of this invention that when the fuel cell separator has “chases A” 23 for transferring gas, which supplies a reaction gas to an electrode on one surface of a metal substrate 21 and “chases B” 24 for cooling, which supplies cooling media on the other surface of the metal substrate 21, at least one of the “chases A” 23 or “chases B” 24 is formed with a conductive resin 22 including a conductive filler.

### CROSS REFERENCE TO RELATED APPLICATION

This application is based on and claims the benefit of priority from the Japanese Patent Application number 2008-123078, filed on May 9, 2008; 2008-237502, filed on Sep. 17, 2008; and 2008-239008, filed on Sep. 18, 2008, the entire contents of which are incorporated herein by reference.

### BACKGROUND OF THE INVENTION

1. Filed of the Invention

This invention relates to a separator for a fuel cell and a manufacturing method thereof. In particular, this invention relates to a separator for a fuel cell which has a metal substrate and its manufacturing method.

2. Description of the Related Art

A fuel cell is a power generation system which transforms chemical energy into electric energy by an electrochemical reaction of a fuel such as hydrogen with an oxidant such as air. Since a fuel cell has advantages such as a high level of power generation efficiency, quiet operation and few harmful byproducts such as NOx and SOx, which pollute air, and CO2, which can cause global warming, many developments are being made in relation to fuel cells.

A power source of a mobile electric device, a power and hot water supplying stationary system of cogeneration, and parts of an automobile are examples of a fuel cell application.

Hence, it is demanded for such a fuel cell to have a high level of durability of more than 10000 hours. A high level of impact resistance is also demanded especially for a non-stationary use such as a mobile electric device and an automobile etc.

Depending on the type of the electrolyte, fuel cells are classified into polymer electrolyte type, phosphoric acid type, molten carbonate type, solid oxide type and alkaline type etc., each of which has a different range of operating temperature, respectively, so that a magnification of power generation and preferable application differs.

Among these, a polymer electrolyte type fuel cell (PEFC) which uses a cation exchange membrane as an electrolyte and direct methanol type fuel cell can operate at a relatively low temperature, and further, is suitable for a compact size and high power use since its internal resistance can be reduced by thinning of the electrolyte membrane.

The polymer electrolyte type fuel cell (PEFC) has a structure of a single layer or a plurality of stacking layers of a unit cell, in which a membrane electrode assembly (MEA) having an anode electrode (fuel electrode) on one surface of the electrolyte membrane and a cathode electrode (oxidant electrode) on the other surface of the electrolyte membrane is arranged between separators via gas diffusion layers.

FIG. 4 is an exemplary diagram of an embodiment of an MEA, which has electrode catalyst layers on both surfaces of the electrolyte membrane. Electrode catalyst layers 2 and 3 are formed stacking on both surfaces of the electrolyte membrane by a conventional means to fabricate MEA 12.

FIG. 5 is an exemplary exploded diagram showing an embodiment of a unit cell of PEFC which includes the MEA 12. As is shown in FIG. 4 and FIG. 5, a conventional unit cell of PEFC has the MEA 12 in which a polymer electrolyte 1 (perfluorocarbon sulfate membrane) is arranged between the catalyst layer 2 of the air electrode (cathode) side and the catalyst layer 3 of the fuel electrode (anode) side, in each of which a catalyst material (for example, platinum (Pt) or a platinum group metal (Ru, Rh, Pd, Os and Ir)) is loaded on carbon black, and the catalyst layer 2 of the air electrode side and the catalyst layer 3 of the fuel electrode side is further arranged between a gas diffusion layer 4 of the air electrode side and a gas diffusion layer 5 of the fuel electrode side to form the MEA having an air electrode and a fuel electrode. Then, the unit cell is fabricated by arranging the MEA between a pair of separators 10 which have chases for transferring reaction gas (gas flow path 8) on the surfaces facing the gas diffusion layer 4 of the air electrode side and the gas diffusion layer 5 of the fuel electrode side along with cooling liquid path 9 for transferring cooling liquid on the other surfaces. Power generation is initiated when an oxidant such as air is supplied to the air electrode 6 and a fuel gas including hydrogen or an organic fuel is supplied to the fuel electrode 7.

In other words, as soon as reaction gases are supplied to the fuel electrode 7 and the air electrode 6 respectively, the following electrochemical reactions take place on a surface of the catalyst particles in the electrode catalyst layers to generate a direct current electric power.

On the fuel electrode side: 2H₂→4H⁺+4e⁻ formula (1)

On the air electrode side: O₂+4H⁺+4e⁻→2H₂O formula (2)

After an occurrence of oxidation of hydrogen molecule (H₂) at the fuel electrode 7 and reduction of oxygen at the air electrode 6, the H⁺ ions produced at the fuel electrode 7 are transferred to the air electrode 6 through the polymer electrolyte membrane 1 and so are the electrons (e⁻) through the external circuit load. Meanwhile, at the air electrode 6, the transferred H⁺ ions and electrons react with oxygen contained in the oxidant gas to produce water. As a result, the PEFC extracts direct current from hydrogen and oxygen, and produces water.

As mentioned above, there are the chases of flow path 8 for transferring fuel on the surface of separator 10 facing the fuel electrode 7. Similarly, there are also the chases of flow path 8 for transferring oxidant gas on the surface of separator 10 which faces the air electrode 6.

A reformed gas mainly composed of hydrogen (or hydrogen gas) or methanol aqueous solution etc. is used as the fuel.

A direct methanol type fuel cell is a fuel cell in which a methanol aqueous solution is directly supplied to the MEA, and is expected to be developed as a portable power source of mobile electric devices (such as, for example, a portable music player, a cell phone, a note PC and a portable TV etc.) because it does not require a gas reformer and can utilize a methanol aqueous solution with high energy density per volume.

The power generating mechanism in the direct methanol type fuel cell takes advantage of the following electrochemical reactions between methanol and oxygen (included in the oxidant gas) at the surface of catalyst particles contained in the catalyst layer 3 of the fuel electrode side and the catalyst layer 2 of the air electrode side via the electrolyte membrane 1 presented in formula 3 to formula 5.

On the fuel electrode side: CH₃OH+H₂O→CO₂+6H⁺+6e⁻ formula (3)

On the air electrode side: 6H⁺+(3/2) O₂+6e⁻→3H₂O formula (4)

Total reaction: CH₃OH+(3/2) O₂→CO₂+2H₂O formula (5)

At the fuel electrode 7, the supplied methanol or its aqueous solution dissociates into a carbon dioxide gas, hydrogen ions and electrons on the catalyst layer 3 of the fuel electrode side by the reaction of formula (3). At this time, a small amount of intermediate compounds such as formic acid etc. are also produced.

The produced hydrogen ions are transferred from the fuel electrode 7 to the air electrode 6 via the electrolyte membrane 1 to react with electron and oxygen gas supplied from air according to formula (4) in the air catalyst layer 2, and produce water.

Although the produced voltage by the unit cell should theoretically be about 1.2 V, it is actually in the range of 0.85-1.0 V due to methanol crossover (which is a phenomenon in which non-reacted methanol at the fuel electrode 7 is transferred to the air electrode 6 via the electrolyte membrane 1), or a resistance that is generated when hydrogen ions pass through the electrolyte membrane 1.

In practice, it is necessary to connect a plurality of unit cells in series in order to obtain a desired voltage for use as a power source because unit cells are usually designed to have a voltage in the range of 0.3-0.6 V under a current density condition of continuous operation.

Fuel cells having a structure of tandemly-stacked unit cells, in each of which the MEA 12 is arranged between the separators 10, are used for the purpose of compactifying the entire fuel cell along with improving output power density. The number of stacked unit cells changes in accordance with the required electric power for the fuel cell. In general, in the case where the fuel cell is applied to a portable power source, the number of stacked unit cells is about in the range of 2-10, while in the case where the fuel cell is applied to a stationary cogeneration system of electric power and hot water, the number of stacked unit cells is about in the range of 60-90, and in the case where the fuel cell is applied to a power system of an automobile, the number of stacked unit cells is about in the range of 250-400.

Since an increase of the number of stacked unit cells is inevitable to generate a high power output, the cost and thickness of the unit cell has a significant influence on the cost and size of the whole fuel cell.

The separator 10 separates a flow path 8 (for fuel) of a unit cell from a flow path 8 (for oxidant gas) of an adjacent unit cell so as to prevent the fuel gas and the oxidant gas from blending together. In addition, if the separator 10 is conductive, it is also possible for the separator 10 to transfer electrons generated in the MEA 12 by a catalyst reaction to an external circuitry.

In addition, in the case where a plurality of unit cells connected in series are used, it is also possible to set penetrating holes (which are not shown in the figures) for combining a plurality of flow paths 8 on the separator in the appropriate regions such as corner regions. Then, it is possible to control the transfer of fuel gas and oxidant gas to adjacent flow paths of unit cells connected in series through these penetrating holes.

In addition, the separator 10 having the chases of flow path 8 shown in FIG. 5 which is applied not only to a PEFC but also to a direct methanol fuel cell was described above. The chases of flow path 8, however, are only an example of flow path 8 so that the shape of flow path 8 is not limited to such chases. The separator may have many penetrating small holes through which methanol is provided (although such holes are not illustrated in FIG. 5).

From such a viewpoint described above, it is necessary for the separator 10 to have a corrosion resistance not only to the fuel gas, the oxidant gas, and water but also to an electrochemically corrosive environment under a strong acidic atmosphere. It is said for example that the internal environment of PEFC, which uses hydrogen as the fuel gas, is comparable to a vitriolic atmosphere of pH=1-2 and a temperature of 70-80° C. The internal environment of a direct methanol type fuel cell is a kind of methanol atmosphere including formic acid, which is an intermediate compound of the cell reaction. In addition, it is also necessary for the separator 10 to have a high level of conductivity in order to effectively extract electric power. An intrinsic resistance (per volume) of the material of the separator 10 and a contact resistance between the separator 10 and the gas diffusion layer (GDL) 4 and 5 (which is made of carbon paper or carbon cloth,) can be factors which cause a decrease in conductivity of the separator 10. In particular, it is generally a problem that the contact resistance between the separator 10 and the gas diffusion layer 4 and 5 is too high.

A carbon separator, which is made from graphite plate and on which the flow path is formed by cutting, has been widely used as the separator 10 to ensure conductivity and corrosion resistance (see patent document 1). It is, however, difficult to make a thin carbon separator because a carbon separator is so brittle and sensitive to mechanical impact and shaking that a graphite plate of a few millimeters thickness is required to make a carbon separator 10.

In addition, attempts are being made to produce the separator 10 by blending a binder made of a polymer such as a thermoplastic resin etc. into carbon powder or carbon fiber, and forming by injection molding etc. (see patent document 2 and 3). Separators obtained in such a way, however, also lack sufficient strength and it is necessary to make the thickness of the separator at least 1-2 mm. As a result, it is hard to produce a thin fuel cell.

Therefore, in order to realize downsizing of fuel cells, an attempt to use a metal separator, which has excellent mechanical strength, has been made in recent years (see patent document 4). There is, however, a disadvantage in a metal separator that metal has generally poor corrosion resistance.

In addition, in order to provide the corrosion resistance and reduce the contact resistance between the separator and the GDL, gold plating may be performed on a surface of the metal separator. For such a case, a technique in which only a material on a conductive media is gilded is disclosed to reduce the total usage of expensive gold (see patent document 5). However, there is a possibility that the conductive media drops off. In addition, although stainless metal is used in the document for fear that a pin hole of gold plating is produced, the corrosion resistance of stainless metal is still insufficient. Moreover, because expensive gold plating having a few μm thickness is required to decrease pinholes according to the document, it is hard to reduce the cost.
<Patent Document 1> JP-A-2001-006703
<Patent Document 2> JP-A-2005-100933
<Patent Document 3> JP-A-2006-179207
<Patent Document 4> JP-A-2002-190305
<Patent Document 5> JP-A-2003-297378

### SUMMARY OF THE INVENTION

As described above, it is necessary for a fuel cell separator to have conductivity, corrosion resistance and mechanical strength along with the capability of thin-sizing. It is a first object of the present invention to provide a low cost fuel cell separator which has sufficient corrosion resistance, mechanical strength and low contact resistance between the separator and the gas diffusion layer along with capability for downsizing (to be thin). It is a second object of the present invention to provide a manufacturing technique which makes it possible to manufacture such a fuel cell separator by a relatively easy method.

After eager inspection to solve the problem mentioned above, the inventors noticed that a low cost fuel cell separator which has sufficient conductivity, corrosion resistance, mechanical strength and capability of thin-sizing can be obtained by a simple method of molding a conductive resin to a silicone resin engraved plate and transferring it to at least one surface of a metal substrate.

A first aspect of the present invention is a fuel cell separator having a substrate and chases which is formed on a surface of the substrate and is mainly made of a conductive resin which includes conductive filler. A second aspect of the present invention is a fuel cell separator having a substrate, chases for transferring gas which supply a reaction gas to an electrode and chases for cooling which supply cooling media, the chases for transferring gas being formed on one surface of the metal substrate, the chases for cooling being formed on the other surface of the metal substrate, and at least one of the chases for transferring gases or the chases for cooling being formed with a conductive resin which includes a conductive filler.

A third aspect of the present invention is a fuel cell separator, wherein the conductive filler is a carbon fiber, a conductive powder, or a mixture of these.

A fourth aspect of the present invention is a fuel cell separator, wherein powder resistivity of the conductive filler is less than or equal to 0.015 Ωcm.

A fifth aspect of the present invention is a fuel cell separator, wherein a depth of the chases for transferring gas and the chases for cooling are in the range of 50-700 μm.

A sixth aspect of the present invention is a fuel cell separator, wherein the metal substrate includes at least one of iron, copper or aluminum.

A seventh aspect of the present invention is a fuel cell separator, wherein a thickness of the conductive resin at the bottom of at least one of the chases for transferring gas or the chases for cooling is in the range of 10-100 μm.

An eighth aspect of the present invention is a manufacturing method of a fuel cell separator having at least chases for gas transferring or chases for cooling which includes filling an engraved plate which is molded from a convex master block with conductive resin ink including conductive filler so that a convex conductive resin is formed, and peeling off the convex conductive resin from the engraved plate to transfer to the metal substrate.

A ninth aspect of the present invention is a manufacturing method, wherein the engraved plate is mainly made of silicone resin.

A tenth aspect of the present invention is a manufacturing method, wherein a convex part of the convex master block is mainly made of a photoresist which is patterned by a photolithography technique.

The present invention provides a low cost separator which has sufficient corrosion resistance, mechanical strength and capability of thin-sizing as well as reduced contact resistance between the separator and the gas diffusion layer. In addition, the present invention provides a manufacturing method of such a fuel cell separator by a relatively simple method.

In addition, according to a preferred embodiment of the present invention, the fuel cell separator is obtained by molding a conductive resin to a silicone resin engraved plate and transferring it to at least one surface of a metal substrate (this is hereinafter called silicone molding method). By forming the conductive resin by the silicone molding method, it easily becomes possible to form the chases of the flow paths for transferring the reaction gases or the cooling liquid as well as to provide the surface of the metal substrate with sufficient corrosion resistance during power generating operation.

In addition, according to the present invention, it is possible to produce a fuel cell separator which is thin and light as well as having a high mechanical strength and robustness since a metal substrate is employed.

In addition, according to the present invention, the fuel cell separator attains conductivity along with a high level of corrosion resistance because the chases are formed on the conductive resin but do not have a depth reaching to the metal substrate so that oxide film growth, which may cause a decrease in conductivity, does not take place in the metal substrate. Furthermore, it is possible to manufacture the fuel cell separator continuously at low cost since a wet process can be applied to the present invention and high cost equipment such as that for a dry process is not required.

### BRIEF DESCRIPTION OF THE DRAWINGS

FIG. 1 is an exemplary diagram showing a cross sectional view of a fuel cell separator of the present invention.

FIG. 2 is an explanatory diagram of a manufacturing method of an engraved plate used for fabricating a fuel cell separator of the present invention.

FIG. 3 is a diagram explaining a manufacturing method of a fuel cell separator of the present invention.

FIG. 4 is a cross-sectional explanatory diagram of an MEA in which electrode catalyst layers are formed on both surfaces of the electrolyte of an embodiment of the present invention.

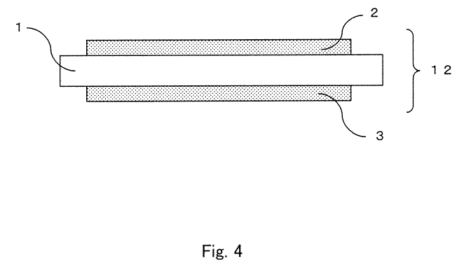

FIG. 5 is an exploded cross sectional diagram showing a unit cell of a fuel cell which includes the MEA shown in FIG. 4.

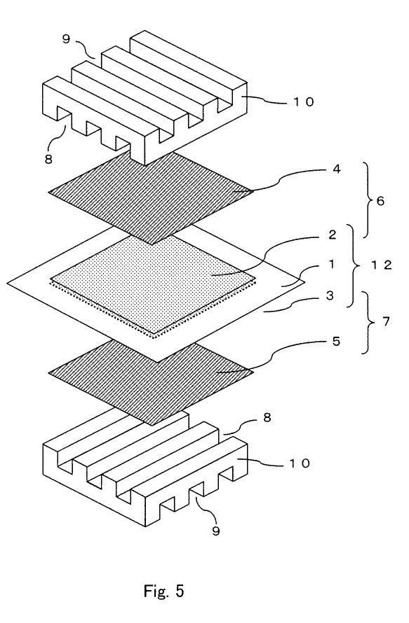

### DESCRIPTION OF REFERENCE NUMERALS AND SIGNS

1: Electrolyte membrane
2: Electrode catalyst layer of the air electrode side
3: Electrode catalyst layer of the fuel electrode side
4: Gas diffusion layer of the air electrode side
5: Gas diffusion layer of the fuel electrode side
6: Air electrode (Cathode)
7: Fuel electrode (Anode)
8: Chases (Flow path for transferring gas)
9: Flow path for transferring cooling liquid
10: Separator
21: Metal substrate
22: Conductive resin
23: Chases A (Flow path for reaction gas)
24: Chases B (Flow path for cooling liquid)
25: Convex master block
25X: Photoresist
25Y: Convex master block substrate
26: Solution including silicone resin
27: Engraved plate (Side of the flow path for reaction gas)
28: Engraved plate (Side of the flow path for cooling liquid)

### DETAILED DESCRIPTION OF THE INVENTION

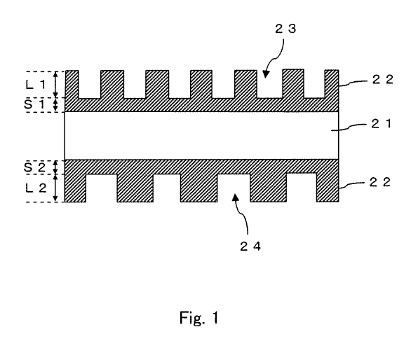

Fuel cell separators of the present invention are described below while referring to the figures. FIG. 1 is an explanatory schematic diagram of an essential part of a fuel cell separator of the present invention. The fuel cell separator of the present invention has chases A 23 for supplying reaction gases on one surface of the metal substrate 21 and chases B 24 for supplying cooling liquid on the other surface of the metal substrate 21 as is shown in FIG. 1. The chases A 23 and the chases B 24 are made of conductive resin including conducting powder of carbon powder as conductive filler. From the viewpoint of forming chases on both surfaces of a plane metal substrate 21, compared with forming flow paths by a press work, the method of this invention has an advantage in that both flow paths can be designed independent from the other to best shape possible. In other words, it is possible to form the shape of the chases B 24 independent from the shape of the chases A 23. In addition, applying a silicone molding method, the present invention allows an integral formation of convex shapes with a height around a few hundred microns, which is not permitted by conventional printing methods.

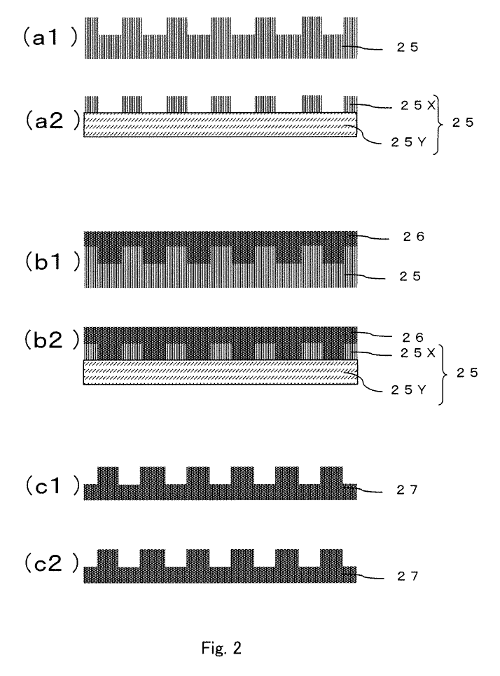

FIG. 2 illustrates a manufacturing method of an engraved plate which is used in the present invention. As is shown in (b1) and (b2) in FIG. 2, the engraved plate 27 having inverted shapes of a convex master block 25 is formed by casting silicone resin solution 26 on the convex master block 25 which has the inverted shapes of the chases A and the chases B and peeling it off after it is cured. The convex master block 25 is preferred to be made of a material which is hard and robust as well as difficult to dissolve or swell in a solvent of a silicone resin solution such as metal and glass etc. In addition, for example, a method in which a substrate of the master block is directly grooved to form the chases, or a method in which the convex shapes are formed on a substrate with a resin by photolithography, etc. can be used as a method for forming convex shapes of the convex master block 25. Any other method can also be used as long as the desired convex shapes without a distortion or deformation are obtained.

FIG. 2 (a1) illustrates a convex master block 25 obtained by the method in which the substrate is directly grooved to form the chases. In addition, FIG. 2 (a2) shows the convex master block 25 obtained by the method in which the convex shapes are formed on the substrate with the resin by photolithography.

A method in which shapes are formed by cutting the metal substrate can be used as the manufacturing method of the convex master block 25 shown in FIG. 2 (a1)

In the manufacturing method of the convex master block 25 shown in FIG. 2 (a2), a negative type or positive type photoresist material layer is formed on a surface of a substrate 25Y of the convex master block. Next, a lithographic exposure is performed through a photomask on which a required light transmitting or shading pattern is drawn. Then, an image is developed so that the convex shaped photoresist 25X is formed on the surface of the substrate 25Y of the convex master block.

It is preferable that the substrate 25Y of the convex master block is made of a material which is not only flat/smooth and chemically resistant to the silicone resin solution but also sufficiently hard and robust so that no strain or distortion in thickness is observed when photoresist layers are stacked. For example, glasses such as iron containing soda-lime glass, iron free soda-lime glass and borosilicate glass etc., and metals such as iron, nickel, aluminum, and alloys of these etc. can be used. In particular, iron free soda-lime glass and borosilicate glass are preferable since they have no optical interference during the lithographic exposure process so that it becomes possible to form fine shapes.

There is a method in which photoresist is sequentially laminated to a desired height followed by a one-shot exposure, an image development and a formation of a convex pattern, and another method in which a routine of an exposure and an image development is repeated layer by layer as a forming method of the convex shaped pattern. The former method is more preferable because the latter method includes many steps and alignment accuracy after the second layer becomes poor since patterns after the second layer must be formed onto the preceding layers.

Any photoresist material can be used as long as it has chemical resistance to the silicone resin solution. Either a negative or positive curing type photoresist can be used and either a liquid state or film state of photoresist can be used. There are photoresists of bichromatic series, poly vinyl cinnamate series and cyclized rubber azide series etc. as the negative type, and photoresists of naphthoquinone azide series and novolac resin series etc. as the positive type. A conventional coating technique such as a spin coater, a roll coater and a dip coater etc. can be employed when coating a liquid type photoresist. A laminator can be employed when coating a dry film photoresist. Using a dry film photoresist is more preferable in the present invention since it is difficult to control a thickness of a layer when coating a liquid type photoresist and is impossible to sequentially coat liquid type photoresists.

Next, it is noted that there is a method of setting a required amount of solution including silicone resin 26 at an edge of the convex master block 25 followed by squeezing it into the chases portion with a stick shaped squeegee and flattening the opposite surface, and another method of filling the convex master block 25 with solution including silicone resin 26 by screen printing etc. as a method of casting solution including silicone resin 26 to the convex master block 25 shown in FIG. 2 (b1) and (b2). Since the degree of flatness of the opposite surface from the engraved face of the engraved plate 27 affects dimensional accuracy, it is necessary that the opposite surface from the engraved face of the engraved plate 27 is formed flat by a manufacturing method of the engraved plate 27.

It becomes easy to exfoliate the engraved plate 27 from the convex master block 25 if the engraved plate 27 is made of silicone resin and has a certain degree of flexibility. However, the engraved plate 27 also needs to have a sufficient strength so that no strain is observed when transferring a conductive resin. The engraved plate 27 is obtained by exfoliating from the convex master block 25 as is shown in FIG. 2 (c1) and (c2). While thermal curing or ultraviolet curing etc. can be applied as a curing method of silicone resin, it is sufficient to select an appropriate curing method corresponding to the composition of the silicone resin. If a silicone resin has dimensional change such as shrinkage etc. after curing, the shape of the convex master block 25 is not properly reproduced by the resin. Thus, it is preferable that a resin is used which has as little dimensional change due to curing as possible.

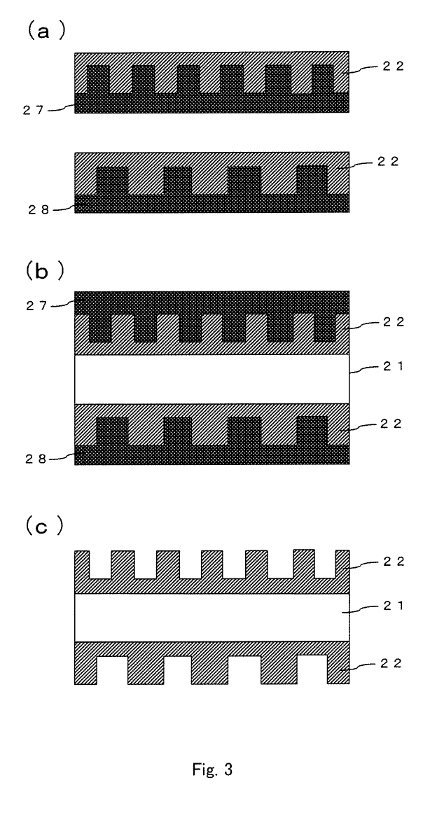

FIG. 3 shows a process for transferring the chases of the present invention. After engraved plates 27 and 28 (the engraved plate 28 forms the chases for cooling) are filled with ink of conductive resin 22 as is shown in FIG. 3(a), a metal substrate 21 is arranged facing the engraved surface of the engraved plate 27 as in FIG. 3(b) and (c), and the conductive resin 22 is transferred to the metal substrate 21 by a roll laminator with a pair of rolls which have a mechanism for pressing an object (a metal substrate with the engraved plates filled with the conductive resin ink) with a certain pressure while sending the object forward. A thickness of the conductive resin 22 which is formed on the metal substrate 21 changes depending on a space between the rolls (in other words, a roll gap), the pressing pressure, a thickness of the metal substrate, and a thickness of an engraved plate of silicone resin at this time. In addition, although it is possible to arrange the conductive resin only at convex parts of the resultant plate, it is desirable that the conductive resin is also arranged at the bottom parts of the chases in order to provide erosion resistance to the entire surface by appropriately adjusting the conditions such as the space between the roles.

In addition, when transferring conductive resin filled in the engraved plate of silicone resin, the conductive resin is preferred to be preliminarily cured to a certain extent. In the case where the ink of the conductive resin includes a solvent component, it takes significant time to cure the ink and in the worst case the curing process does not finish since there is no exit path of the solvent when transferring or a large amount of dimensional change may appear after drying and curing. For the purpose of preventing such a problem, the conductive resin is preferred to be preliminarily in a half-cured state. In addition, while it is possible to transfer the conductive resin in a full-cured state, it is necessary to prepare an adhesive agent for providing adhesiveness to the metal substrate which unnecessarily increases the number of processes and material which is inefficient.

A material which has sufficient strength can be selected as the metal substrate of the fuel cell separator of the present invention without considering the erosion resistance of the metal itself because the metal substrate is protected sufficiently with the conductive resin to obtain erosion resistance. Hence, a metal among pure iron, iron alloy, pure copper, copper alloy, aluminum and aluminum alloy etc. can be used. The material for the metal substrate should be selected according to the application of the fuel cell. It is preferable that a metal with light specific gravity such as aluminum or aluminum alloy is selected if the application requires weight saving as in the case of a mobile electric device or a vehicle etc.

It is necessary for the conductive resin which is used in the present invention to have a sufficient electric conductivity and a sufficient chemical resistance to an oxidant (oxygen, or its blend gases), a fuel (hydrogen, reformed hydrogen gas, or methanol etc.) for the fuel cell and a strong acidic atmosphere. A conductive resin containing conductive filler which makes it possible to form a membrane rapidly in a relatively simple way can be used as the conductive resin in the present invention.

There is no particular limitation to a resin component of the conductive resin of the present invention as long as the resin has sufficient erosion resistance under a power generating condition and wet coating capability. Specifically, for example, phenol resin, epoxy resin, silicone resin, fluororesin, aromatic polyimide resin, polyamide, polyamide imide, polyethylene terephthalate and polyether ether ketone etc., and a mixture of any combination of these can be used as the resin component of the conductive resin. From the view point of improving erosion resistance, fluororesin is desirable. Considering mechanical strength, a molecular weight (represented by a mass mean molecular weight, for example) of these resin is preferred to be as large as 10 thousand to 10 million (more preferably 20 thousand to 5 million) unless processability such as wet coating capability is severely sacrificed.

Fibrous conductive filler or powdery conductive filler can be used as the conductive filler of the present invention. Specifically, carbon fibers including one or more among carbon nanofibers and carbon nanotubes etc. are examples of the fibrous conductive filler. The carbon fibers are preferred to have powder resistivity less than 0.015 Ωcm and monofilament specific resistance less than 1 mΩcm.

Conductivity of the conductive resin (coated as a protection membrane) of the present invention can be improved by using together with both the fibrous conductive filler and the powdery conductive filler. There is no particular limitation to the powdery conductive filler as long as it has sufficient conductivity and erosion resistance under the power generating condition. Specifically, carbon powders such as acetylene black, vulcan and Ketjenblack etc., metal carbides such as WC and TiC etc., metal nitrides such as TiN and TaN etc., metal silicides such as TiSi and ZrMoSi etc., erosion resistive metals such as Ag and Au or a mixture which selectively includes any one or more of these is an example of the powdery conductive filler. The powdery conductive filler is preferred to have powder resistivity less than 0.015 Ωcm and a monofilament specific resistance less than 1 mΩcm so as to obtain high conductivity.

Considering erosion resistance, conductivity and cost etc., it is preferable that the conductive filler of the present invention is a fibrous carbon or a mixture of fibrous carbon and powdery carbon.

Chemical processes such as wet etching etc., mechanical processes such as pressing and cutting etc. or processes which can remove a portion of the metal substrate such as electric discharging etc. are available as a technique for forming penetrating holes on the metal substrate as a flow path of the reaction gas. Considering productivity, the pressing and the wet etching are preferable because a large area can be treated by these processing.

The size of the penetrating hole and the chases may differ depending on the type and application of the fuel cell. However, it is at least necessary to evenly and stably provide the MEA with sufficient fuel gas and oxidant gas sufficient to generate electric power required by the application. In order to supply the fuel gas and oxidant gas to all power generating sites, it is preferred to arrange the chases as a flow path which transfer reaction gases on a number of parts of the separator. Furthermore, in order to supply the gases evenly in-a-plane, the chases are preferred to meander all around as well as to be combined with a plurality of penetrating holes which reach to spots adjacent to the power generating sites.

A solid content concentration of the conductive resin solution including conductive filler needs to be adjusted appropriately considering erosion resistance, mechanical strength, electric resistance and capability of thin-sizing etc.

If a thickness of a convex portion which is formed with the conductive resin (corresponding to a depth of the chases L1 and L2) is too thick, conductivity of the resin may decrease too much, while if the thickness of the convex portion is too thin, flow resistance may increase so much that the flow path no longer transfers sufficient reaction gas and cooling media. Considering erosion resistance, mechanical strength, electric resistance and capability of thin-sizing, the thickness L1 and L2 of the convex portion is preferred to be in the range of 50-700 μm. In addition, in the case where a conductive resin layer is also formed at the bottom of the chases, the thickness of the conductive resin layer is preferred to be more than (or equal to) 10 μm because if the conductive resin layer is too thin, mechanical strength and erosion resistance may decrease and pinholes may be produced.

A composition ratio of the conductive filler to the resin component, which in general depends on the type of materials, is preferred to be more than (or equal to) 25% by volume after forming a layer if carbon nanofiber as a carbon fiber and acetylene black as a carbon powder are mixed and used as the conductive filler. If the composition ratio of the conductive filler is less than 25% by volume, it is difficult to obtain sufficient conductivity.

At least one of the thicknesses (S1 and S2) of the conductive resin at the bottom of the chases for transferring gases and at the bottom of the chases for cooling, both of which are formed with the conductive resin, is preferred to be in the range of 10-100 in the separator of the present invention. In the case where the thickness of the conductive resin at the bottom of the chases 23 for transferring gases or the chases 24 for cooling is too thick, the conductivity may decrease too much. Meanwhile, in the case where the thickness of these is too thin, the mechanical strength and erosion resistance may decrease and pinholes may be produced. Considering erosion resistance, mechanical strength, electric resistance and capability of thin-sizing, the thicknesses (S1 and S2) of the conductive resin at the bottom of the chases are preferred to be in the range of 10-100 μm.

### EXAMPLES

Examples of the present invention are described below. The present invention, however, is not limited to these examples.

### Example 1

### <Fabrication of the Master Blocks>

1 mm thick stainless steel plates (SUS 304) were prepared as metal substrates and the shapes of flow paths having predetermined chases were formed on the surface by cutting processing. Lines of chases with a width of 1 mm, a depth of 0.5 mm and a pitch of 2 mm were formed on a “plate A” so that a “master block A” was fabricated, while lines of chases with a width of 2 mm, a depth of 0.5 mm and a pitch of 3 mm were formed on a “plate B” so that a “master block B” was obtained.

### <Fabrication of the Silicone Rubber Engraved Plates>

An “A liquid” and a “B liquid” of a liquid silicone rubber (or a solution including silicone resin) TSE3402 (which included polyalkyl alkenyl siloxane and silica as major components and was made by Momentive Performance Materials Japan Inc.) was mixed together and stirred sufficiently. Subsequently, surfaces of the “master block A” and the “master block B” mentioned above were filled with TSE3402 using an applicator bar and were kept at room temperature for 48 hours to cure. The resultant TSE3402s, which cured completely, were peeled off from the master blocks respectively so that a “silicone rubber engraved plate A” and a “silicone rubber engraved plate B” were obtained. The “silicone rubber engraved plate A” and the “silicone rubber engraved plate B” have good frontal surface shapes of concavities and convexities. In addition, plane and even rear surfaces were obtained. The height from the bottom of the concavities to the top of the convexities was 0.5 mm and the thickness between the rear surface and the top of the convexities on the frontal surface was 1 mm.

### <Fabrication of the Separator>

The separator was fabricated as follows using the silicone rubber engraved plates. First, DOTITE A-3, which included 10-20% by weight of carbon black, and DOTITE C-3, which included 20-30% by weight of carbon black, (both of these were made by Fujikurakasei Co., Ltd.) were mixed together with a ratio of 1:1 to obtain DOTITE A-3/C-3 as a conductive resin. Subsequently, the “silicone rubber engraved plate A” and the “silicone rubber engraved plate B” were filled up with the DOTITE A-3/C-3 using the applicator bar. After penetrating holes were punched on a 1 mm thick aluminum plate (A 1050) by press-cutting, the aluminum plate was immersed in a surface treating liquid (1% by weight solution of C-7401 made by ADEKA Corp.) at room temperature for 40 seconds, followed by washing with purified water and dried. Then, the “silicone rubber engraved plate A” and the “silicone rubber engraved plate B” which were filled up with DOTITE A-3/C-3 as described above were fixed on the aluminum plate respectively by a roll laminator (with a loading pressure of 0.3 MPa at room temperature) after being arranged in such a way that each silicone (the DOTITE A-3/C-3) filling surface faced the aluminum substrate in alignment with the predetermined positions. The space between the upper and lower rolls of the roll laminator then was 3 mm. Next, the sample (of aluminum plate combined with the “silicone rubber engraved plates” via the conductive resins) was heated at 150° C. for 30 minutes in an oven to cure the conductive resin. Afterwards, both the “silicone rubber engraved plate A” and the “silicone rubber engraved plate B” were peeled off from the sample to obtain a separator with intended shapes.

### Example 2

### <Fabrication of the Convex Master Blocks>

1 mm thick stainless steel plates (SUS 304) were prepared as metal substrates and shapes of flow paths having predetermined chases were formed on the surface by cutting processing. Lines of chases with a width of 1 mm, a depth of 0.5 mm and a pitch of 2 mm were formed on a “plate A” so that a “master block A” was fabricated, while lines of chases with a width of 2 mm, a depth of 0.3 mm and a pitch of 3 mm were formed on a “plate B” so that a “master block B” was obtained.

### <Fabrication of the Silicone Rubber Engraved Plates>

An “A liquid” and a “B liquid” of a liquid silicone rubber (or a solution including silicone resin) TSE3402 (which included polyalkyl alkenyl siloxane and silica as major components and was made by Momentive Performance Materials Japan Inc.) were mixed together and stirred sufficiently. Subsequently, surfaces of the “master block A” and the “master block B” described above were filled with TSE3402 using an applicator bar and kept at room temperature for 48 hours to cure. The resultant TSE3402s, which were cured completely, were peeled off from the master blocks respectively so that a “silicone rubber engraved plate A” and a “silicone rubber engraved plate B” were obtained. The “silicone rubber engraved plate A” and the “silicone rubber engraved plate B” have good frontal surface shapes of concavities and convexities. In addition, plane and even rear surfaces were obtained. The height from the bottom of the concavities to the top of the convexities was 0.5 mm and the thickness between the rear surface and the top of the convexities on the frontal surface was 1 mm in the “silicone rubber engraved plate A”. The height from the bottom of the concavities to the top of the convexities was 0.3 mm and the thickness between the rear surface and the top of the convexities on the frontal surface was 1 mm in the “silicone rubber engraved plate B”.

### <Fabrication of the Separator>

The separator was fabricated as follows using the silicone rubber engraved plates. First, DOTITE A-3, which included 10-20% by weight of carbon black, and DOTITE C-3, which included 20-30% by weight of carbon black, (a two liquid curing type conductive resin made by Fujikurakasei Co., Ltd.) were mixed together with a ratio of 1:1 to obtain DOTITE A-3/C-3 as a conductive resin. Subsequently, the “silicone rubber engraved plate A” and the “silicone rubber engraved plate B” were filled with the DOTITE A-3/C-3 using the applicator bar. After penetrating holes were punched on a 1 mm thick aluminum plate (A 1050) by press-cutting, the aluminum plate was immersed in a surface treating liquid (1% by weight solution of C-7401 made by ADEKA Corp.) at room temperature for 40 seconds, followed by washing with purified water and dried. Then, the “silicone rubber engraved plate A” and the “silicone rubber engraved plate B” which were filled with DOTITE A-3/C-3 as described above were fixed on the aluminum plates respectively by a roll laminator (with a loading pressure of 0.3 MPa at room temperature) after being arranged in such a way that each silicone (the DOTITE A-3/C-3) filling surface faced the aluminum substrate in alignment with the predetermined positions. The space between the upper and lower rolls of the roll laminator at that time was 3 mm. Next, the sample (of the aluminum plate combined with the “silicone rubber engraved plates” via the conductive resins) was heated at 150° C. for 30 minutes in an oven to cure the conductive resin. Afterwards, both the “silicone rubber engraved plate A” and the “silicone rubber engraved plate B” were peeled off from the sample to obtain the separator with intended shapes.

### Example 3

### <Fabrication of the Convex Master Blocks>

A 1 mm thick borosilicate glass plate which was washed with a surfactant agent was laminated with a 56 μm thick negative type dry film photoresist (HM-4056 made by Hitachi Chemical Co., Ltd.) on both surfaces four times using a roll laminator with a roll pressure of 0.3 MPa at a roll temperature of 110° C. Afterwards, the glass plate was covered with a photomask which was designed to shield parts to be convexities in the separator from light and exposed to ultraviolet ray. Then, an image was developed by spraying alkali solution (1 wt % of sodium carbonate solution) with a pressure 0.1 MPa so that a pattern of the photoresist with the same size as that of the photomask was formed. This pattern of the photoresist was used as the convex master block. A “master block A” had linear and parallel chases with 0.2 mm of aperture width and 1 mm of chase pitch, while a “master block B” had linear and parallel chases with 0.1 mm of aperture width and 2 mm of chase pitch

### <Fabrication of the Silicone Rubber Engraved Plates>

An “A liquid” and a “B liquid” of a liquid silicone rubber (or a solution including silicone resin) TSE3402 (which included polyalkyl alkenyl siloxane and silica as major components and was made by Momentive Performance Materials Japan Inc.) were mixed together and stirred sufficiently. Subsequently, surfaces of the “master block A” and the “master block B” described above were filled with TSE3402 using an applicator bar and kept at room temperature for 48 hours to cure. The resultant TSE3402s, which cured completely, were peeled off from the master blocks respectively so that a “silicone rubber engraved plate A” and a “silicone rubber engraved plate B” were obtained. The “silicone rubber engraved plate A” and the “silicone rubber engraved plate B” have good frontal surface shapes of concavities and convexities. In addition, plane and even rear surfaces were obtained. The height from the bottom of the concavities to the top of the convexities was 0.3 mm and the thickness between the rear surface and the top of the convexities on the frontal surface was 1 mm in the “silicone rubber engraved plate A”. The height from the bottom of the concavities to the top of the convexities was 0.2 mm and the thickness between the rear surface and the top of the convexities on the frontal surface was 1 mm in the “silicone rubber engraved plate B”.

### <Fabrication of the Separator>

The separator was fabricated as follows using the silicone rubber engraved plates. First, DOTITE A-3, which included 10-20% by weight of carbon black, and DOTITE C-3, which included 20-30% by weight of carbon black, (two liquid curing type conductive resin made by Fujikurakasei Co., Ltd.) were mixed together with a ratio of 1:1 to obtain DOTITE A-3/C-3 as a conductive resin. Subsequently, the “silicone rubber engraved plate A” and the “silicone rubber engraved plate B” were filled with the DOTITE A-3/C-3 using the applicator bar. Meanwhile, after penetrating holes were punched on a 1 mm thick aluminum plate (A 1050) by press-cutting, the aluminum plate was immersed in a surface treating liquid (1% by weight solution of C-7401 made by ADEKA Corp.) at room temperature for 40 seconds, followed by washing with pure water and dried. Then, the “silicone rubber engraved plate A” and the “silicone rubber engraved plate B” which were filled with DOTITE A-3/C-3 as described above were fixed on the aluminum plates respectively by a roll laminator (with a loading pressure of 0.3 MPa at room temperature) after being arranged in such a way that each silicone (the DOTITE A-3/C-3) filling surface faced the aluminum substrate in alignment with an predetermined position. The space between the upper and lower rolls of the roll laminator then was 3 mm. Next, the sample (of the aluminum plate combined with the “silicone rubber engraved plates” via the conductive resin) was heated at 150° C. for 30 minutes in an oven to cure the conductive resin. Afterwards, both the “silicone rubber engraved plate A” and the “silicone rubber engraved plate B” were peeled off from the sample to obtain the separator with intended shapes.

### INDUSTRIAL APPLICABILITY

The fuel cell separator of the examples of the present invention had “chases A” for supplying gases, which transferred reaction gases to electrodes, on one surface of a metal substrate and “chases B” for cooling, which transferred cooling media, on the other surface of the metal substrate. Further, it was a feature of the fuel cell separator of the examples of the present invention that at least one of the “chases A” for supplying gases and the “chases B” for cooling was made of a conductive resin including conductive filler. Thus, at least one of the “chases A” and the “chases B” could easily be formed on both surfaces of the separator as shapes of flow paths with about 50-500 μm thick membrane patterns by transferring the convex shapes of the conductive resin to the metal substrate after filling the engraved plate which was molded from the convex master block with the conductive resin ink including the conductive fillers. In addition, in the case where powdery conductive filler was used, conductivity of the conductive and erosion resistive membrane was improved as well as a high level of mechanical strength and robustness was maintained and it became possible to save weight and thickness for the sake of the usage of the metal substrate. Moreover, although a metal substrate was used in the examples of the present invention, a remarkable effect of a high erosion resistance and a high electric conductivity was obtained without a decrease in conductivity caused by a growth of an oxide membrane, which was often observed when a metal substrate was used, because the entire frontal surface of the metal substrate was covered with the conductive resin.

What is claimed is:

1. A fuel cell separator comprising:
a substrate; and
chases, said chases being formed on a surface of said substrate, and said chases comprising mainly a conductive resin which includes a conductive filler.

2. A fuel cell separator comprising:
a metal substrate;
chases for transferring gases which supply a reaction gas to an electrode; and
chases for cooling which supply cooling media, said chases for transferring gases being formed on one surface of said metal substrate, said chases for cooling being formed on the other surface of said metal substrate, and at least one of said chases for transferring gases or said chases for cooling comprising a conductive resin which includes a conductive filler.

3. The fuel cell separator according to claim 2, wherein said conductive filler is a carbon fiber, a conductive powder, or a mixture of these.

4. The fuel cell separator according to claim 3, wherein a powder resistivity of said conductive filler is less than or equal to 0.015 Ωcm.

5. The fuel cell separator according to claim 2, wherein a depth of said chases for transferring gases and said chases for cooling is in the range of 50-700 μm.

6. The fuel cell separator according to claim 3, wherein a depth of said chases for transferring gases and said chases for cooling is in the range of 50-700 μm.

7. The fuel cell separator according to claim 4, wherein a depth of said chases for transferring gases and said chases for cooling is in the range of 50-700 μm.

8. The fuel cell separator according to claim 2, wherein said metal substrate comprises at least one of iron, copper and aluminum.

9. The fuel cell separator according to claim 3, wherein said metal substrate comprises at least one of iron, copper and aluminum.

10. The fuel cell separator according to claim 4, wherein said metal substrate comprises at least one of iron, copper and aluminum.

11. The fuel cell separator according to claim 7, wherein said metal substrate comprises at least one of iron, copper and aluminum.

12. The fuel cell separator according to claim 2, wherein a thickness of said conductive resin at a bottom of at least one of said chases for transferring gases or said chases for cooling is in the range of 10-100 μm.

13. The fuel cell separator according to claim 3, wherein a thickness of said conductive resin at a bottom of at least one of said chases for transferring gases or said chases for cooling is in the range of 10-100 μm.

14. The fuel cell separator according to claim 4, wherein a thickness of said conductive resin at a bottom of at least one of said chases for transferring gases or said chases for cooling is in the range of 10-100 μm.

15. The fuel cell separator according to claim 7, wherein a thickness of said conductive resin at a bottom of at least one of said chases for transferring gases or said chases for cooling is in the range of 10-100 μm.

16. The fuel cell separator according to claim 11, wherein a thickness of said conductive resin at a bottom of at least one of said chases for transferring gases or said chases for cooling is in the range of 10-100 μm.

17. A method of manufacturing a fuel cell separator which has at least chases for transferring gas or chases for cooling, the method comprising:
filling an engraved plate which is molded from a convex master block with conductive resin ink including conductive filler so that a convex conductive resin is formed; and
peeling off said convex conductive resin from said engraved plate to transfer to said metal substrate.

18. The method according to claim 17, wherein said engraved plate comprises mainly silicone resin.

19. The method according to claim 17, wherein a convex part of said convex master block comprises mainly a photoresist which is patterned by a photolithography technique.

20. The method according to claim 18, wherein a convex part of said convex master block comprises mainly a photoresist which is patterned by a photolithography technique.
